(19) United States
(12) Patent Application Publication
(10) Pub. No.: US 2023/0080306 A1
(43) Pub. Date: Mar. 16, 2023

(54) VEHICLE CONTROL DEVICE AND CONTROL METHOD FOR TRANSMITTING INFORMATION THROUGH PORTABLE EXTERNAL DEVICES

(71) Applicants: Hyundai Motor Company, Seoul (KR); Kia Corporation, Seoul (KR)

(72) Inventor: Yong Sik Cho, Anyang (KR)

(21) Appl. No.: 17/846,195

(22) Filed: Jun. 22, 2022

(30) Foreign Application Priority Data
Sep. 15, 2021 (KR) 10-2021-0123435

(51) Int. Cl. B60W 50/14; B60W 30/08; B60W 30/12; G01C 21/36

(52) U.S. Cl. CPC B60W 50/14; B60W 30/08; B60W 30/12; G01C 21/3629; B60W 2050/143; B60W 2556/50

(57) ABSTRACT

A vehicle control device includes a memory, a network interface, and a processor that connects to a portable external device through a communication channel, identifies a position of an occupant carrying or wearing the portable external device, determines whether the occupant is a driver or a passenger based on the position of the occupant, and transmits sound data for providing a sound service suitable for the occupant to the portable external device according to whether the occupant is the driver or the passenger.

### CROSS-REFERENCE TO RELATED APPLICATION

Tis application claims under 35 U.S.C. § 119(a) the benefit of Korean Patent Application No. 10-2021-0123435, filed in the Korean Intellectual Property Office on Sep. 15, 2021, the entire contents of which are incorporated herein by reference.

### BACKGROUND

### (A) Technical Field

The present disclosure relates to a vehicle control device and a control method therefor, more particularly, to a technology for controlling the vehicle control device such that the vehicle control device provides services through portable external devices.

### (b) Description of the Related Art

A vehicle control device may be connected to an external device located a short distance away through a communication channel. The vehicle control device may interwork with a portable external device carried by an occupant in a vehicle. The vehicle control device may provide a service through the portable external device. The service may include an operation of providing information to a user by outputting a guide sound or a waring sound to a user who carries or wears the portable external device. For example, the vehicle control device may provide a warning sound to a driver through earphones by interworking with the earphones worn by a driver. The vehicle control device may transmit driving-related information and warning information to the earphones while the driver is driving the vehicle. When a plurality of occupants in the vehicle each carry a portable external device, the vehicle control device may uniformly interwork with the plurality of portable devices in the vehicle using a single communication channel.

As the use of portable external devices increases, each occupant of a vehicle may carry a portable external device. As the use of portable external devices increases, there is an increasing need for personalized services for each occupant in the vehicle. When a plurality of occupants in the vehicle each carry a portable external device, the vehicle control device may transmit only the same information to the plurality of portable external devices when the vehicle control device uniformly interworks with the plurality of portable devices. Accordingly, it may not be easy to provide a personalized service to each occupant by providing different information to the plurality of portable external devices.

In particular, services required by the driver and passengers may be different. When the same information is provided to the portable external device carried by the driver and the portable external device carried by the passenger, it is not easy to provide personalized services for the driver and passengers, and unnecessary services may be provided to the driver and passengers.

### SUMMARY

An aspect of the present disclosure provides a vehicle control device and a vehicle control method capable of extending a function of interworking with each of a plurality of portable devices when a vehicle control device interworks with the plurality of portable devices in a vehicle.

Further, according to an embodiment of the present disclosure, when the vehicle control device interworks with a plurality of portable devices in the vehicle, the vehicle control device distinguishes information required for each of the driver and the passenger and provides different information to the portable external devices carried by the driver and the portable external device carried by the passenger to provide a personalized service suitable for the driver and the passenger.

In addition, the embodiment of the present disclosure provides information differentially according to the priority of information required for the portable external device carried by the driver and the portable external device carried by the passenger, thereby reducing unnecessary services provided to the driver and passengers and increasing the effectiveness of personalized services.

The technical problems of the present disclosure are not limited to the aforementioned problems, and any other technical problems not mentioned herein will be clearly understood from the following description by those skilled in the art.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control device may include a memory, a network interface, and a processor, and the processor may connect to a portable external device through a communication channel, identify a position of an occupant carrying or wearing the portable external device, determine whether the occupant is a driver or a passenger based on the position of the occupant, and transmit sound data for providing a sound service suitable for the occupant to the portable external device according to whether the occupant is the driver or the passenger.

According to an embodiment, the processor may receive a user position signal from a sensor in a vehicle to identify the position of the occupant

According to an embodiment, the processor may provide first sound data related to a driving-related warning and route guidance to the portable external device in response to the occupant being the driver.

According to an embodiment, the first sound data may include a driving-related notification, a navigation route guidance sound, a speed camera warning sound, a lane departure warning, a front/rear parking assist sensor warning sound, and a rear blind spot warning sound, which are unnecessary for passengers.

According to an embodiment, the processor may provide second sound data related to guidance and convenience services to the portable external device in response to the occupant being the passenger.

According to an embodiment, the second sound data may include an ambulance/police car approaching notification and a front/rear collision warning.

According to an embodiment, the processor may control the portable external device of the driver such that the portable external device of the driver outputs a driving warning sound, a guidance sound, and a media when interlocking with the portable external device of the driver when the passenger is absent in a vehicle.

According to an embodiment, the processor may control a sound system of the vehicle to turn off the sound system of the vehicle or to output a sound to assist the portable external device of the driver.

According to an embodiment, the processor may control a sound system of a vehicle to remove a driving-related guide sound when interworking with the portable external device of the driver under condition that the driver and the passenger are riding together in the vehicle.

According to an embodiment, the processor may independently manage a priority of a sound service for the portable external device of the driver and a priority of a sound service for the portable external device of the passenger.

According to an aspect of the present disclosure, a vehicle control method may include connecting, by a vehicle control device, to a portable external device through a communication channel, identifying, by a processor of the vehicle control device, a position f an occupant carrying or wearing the portable external device, determining, by the processor, whether the occupant is a driver or a passenger based on the position of the occupant, and transmitting, by the processor, sound data for providing a sound service suitable for the occupant to the portable external device according to whether the occupant is the driver or the passenger.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a system including a vehicle control device according to an embodiment of the present disclosure;

FIG. 2 is a block diagram illustrating a system including a vehicle control device according to an embodiment of the present disclosure;

FIG. 3 is a diagram illustrating a control method in which a vehicle control device provides a service for outputting a guide sound or a warning sound through a portable external device according to an embodiment of the present disclosure;

FIG. 4 is a flowchart illustrating a method of outputting, by a vehicle control device, a notification according to a situation in consideration of a position of each of a plurality of portable external devices according to an embodiment of the present disclosure;

FIG. 5 is a flowchart illustrating a method for independently providing a sound service to each of a plurality of portable external devices in a vehicle control device according to an embodiment of the present disclosure;

FIG. 6 is a flowchart illustrating a method for determining services provided by a plurality of portable external devices in a vehicle control device according to a priority according to an embodiment of the present disclosure;

FIG. 7 is a flowchart illustrating a method for determining a position of a user of a portable external device in a vehicle control device according to an embodiment of the present disclosure;

FIG. 8 is a diagram illustrating a personalized service provided by each of a plurality of portable external devices according to an embodiment of the present disclosure;

FIG. 9 is a diagram illustrating a personalized service provided by an external device according to an embodiment of the present disclosure; and

FIG. 10 illustrates a computing system according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

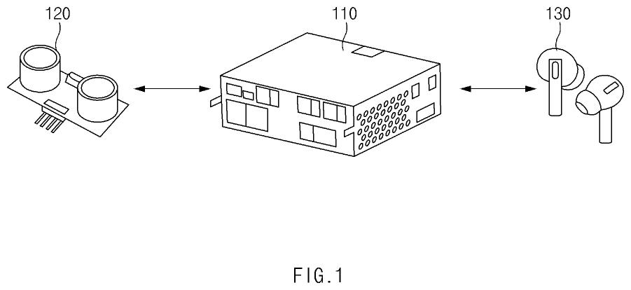

Embodiments of the present disclosure will be described below in detail with reference to FIGS. 1 to 10.

FIG. 1 is a diagram illustrating a system including a vehicle control device according to an embodiment of the present disclosure. A system according to an embodiment of the present disclosure may include a vehicle control device 110, a sensor 120, and a portable external device 130.

The vehicle control device 110 may request occupant position information from the sensor 120. The occupant position information may include data on a position in which each occupant in the vehicle sits in a seat. The vehicle control device 110 may obtain the occupant position information from the sensor 120.

The vehicle control device 110 may generate notification information. The notification information may include first notification information necessary for a driver and second notification information necessary for a passenger. The first notification information may include driving-related information of the vehicle. For example, the first notification information may include a guide for a sign on a road on which the vehicle is driving, a warning for an accident risk factor around the vehicle, a guide for a driving speed of the vehicle, and a guide for a condition of the vehicle, such as a tire pressure of the vehicle. The second notification information may include driving-related information of the vehicle. For example, the second notification information may include a guide for places around the road on which the vehicle is driving, a warning for an actual collision accident, and a guide for approaching of an emergency vehicle such as an ambulance or a police car.

The vehicle control device 110 may generate sound data. The sound data may include first sound data and second sound data. The first sound data may be data representing the first notification information in a sound manner. The second sound data may be data representing the second notification information in a sound manner.

The vehicle control device 110 may transmit sound data to the portable external device 130. The vehicle control device 110 may select sound data to be transmitted to the portable external device 130 based on the occupant position information. For example, the vehicle control device 110 may transmit the first sound data to the portable external device 130 determined to be carried or worn by the driver. As another example, the vehicle control device 110 may transmit the second sound data to the portable external device 130 determined to be carried or worn by the passenger.

The sensor 120 may be mounted in the vehicle to detect a position of an occupant. The sensor 120 may generate occupant position information using the detected position of the occupant. The sensor 120 may transmit the occupant position information to the vehicle control device 110.

The portable external device 130 may be an electronic device carried by each occupant. For example, the portable external device 130 may be a wireless earphone. However, the present disclosure is not limited thereto, and the portable external device 130 may be an electronic device capable of receiving sound data from the vehicle control device 110 through wireless communication and outputting a sound according to the sound data. The portable external device 130 may output a sound according to the sound data received from the vehicle control device 110. The portable external device 130 worn by the driver may receive the first sound data from the vehicle control device 110 and output the first notification information in a sound manner. The portable external device 130 worn by the passenger may receive the second sound data from the vehicle control device 110 and output the second notification information in a sound manner. Accordingly, personalized notification information suitable for each of the driver and the passenger may be output.

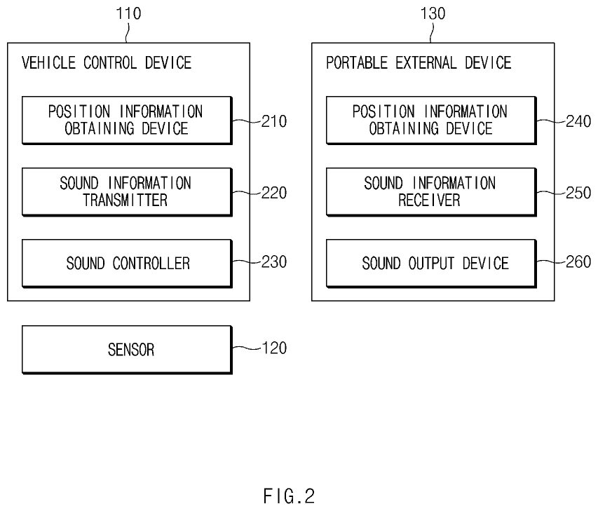

FIG. 2 is a block diagram illustrating a system including a vehicle control device according to an embodiment of the present disclosure.

The vehicle control device 110 may determine a seating position of a vehicle occupant. The vehicle control device 110 may determine whether each vehicle occupant is seated and a seating position for each vehicle seat using the sensor 120. The vehicle control device 110 may provide a specific sound service according to an identified user position.

The vehicle control device 110 may include a position information obtaining device 210, a sound information transmitter 220, and a sound controller 230.

The position information obtaining device 210 may receive a user position signal from the sensor 120. The user position signal may include passenger position information. The position information obtaining device 210 may transmit the user position signal to the portable external device 130.

The sound information transmitter 220 may transmit sound data to the portable external device 130. The sound information transmitter 220 may transmit data representing the notification information in a sound manner.

The sound controller 230 may allow the sound information transmitter 220 to transmit sound data to the portable external device 130. The sound controller 230 may transmit the sound data to the portable external device 130 to provide a sound service differentiated for each user. The sound controller 230 may allow the sound information transmitter 220 to provide independent sound data for each user.

The sound controller 230 may distinguish between sound data provided to the portable external device 130 carried or worn by the driver and sound data provided to the portable external device 130 carried or worn by the passenger. The sound controller 230 may provide a driving-related warning and route guidance sound data to the portable external device 130 carried or worn by the driver. The sound controller 230 may provide sound data related to guidance and convenience services to the portable external device 130 carried or worn by the passenger.

The portable external device 130 may include a position information obtaining device 240, a sound information receiver 250, and a sound output device 260.

The position information obtaining device 240 may receive a user position signal from the vehicle control device 110. The position information obtaining device 240 may receive the occupant position information from the vehicle control device 110.

The sound information receiver 250 may receive sound data from the vehicle control device 110. The sound information receiver 250 may receive sound data related to a warning generated when the vehicle is driving. The sound information receiver 250 may receive sound data related to guidance when the vehicle is driving.

The sound output device 260 may output sound. The sound output device 260 may output a warning sound or a guide sound according to the sound data received from the vehicle control device 110. When sound data is not received from the vehicle control device 110, the sound output device 260 may output a personalized conversation sound or a media sound.

In an embodiment, the vehicle control device 110 may determine a state of an occupant using use the sensor 120. For example, when the sensor 120 is a heart rate sensor such as a radar sensor, the vehicle control device 110 may determine a heart rate of the occupant using use the sensor 120. The vehicle control device 110 may independently provide a sound service required for each vehicle passenger to the portable external device 130 of the each vehicle passenger. For example, the vehicle control device 110 may provide a sound service capable of reducing motion sickness to the portable external device 130 of an occupant experiencing motion sickness through the sensor 120. As another example, the vehicle control device 110 may provide a warning sound to the portable external device 130 of the driver who is drowsy through the sensor 120. As another example, the vehicle control device 110 may provide a sleep mode sound service to the portable external device 130 of a passenger who is drowsy through the sensor 120.

The vehicle control device 110 may obtain information on the number of occupants and occupant position information through the portable external device 130 carried or worn by each of the occupants of the vehicle. The vehicle control device 110 may personalize and provide a sound service and a vehicle convenience function by using the number of occupants and the occupant position information. For example, the vehicle control device 110 may independently provide lighting control, airbag control, and/or air conditioning control for each occupant's seat.

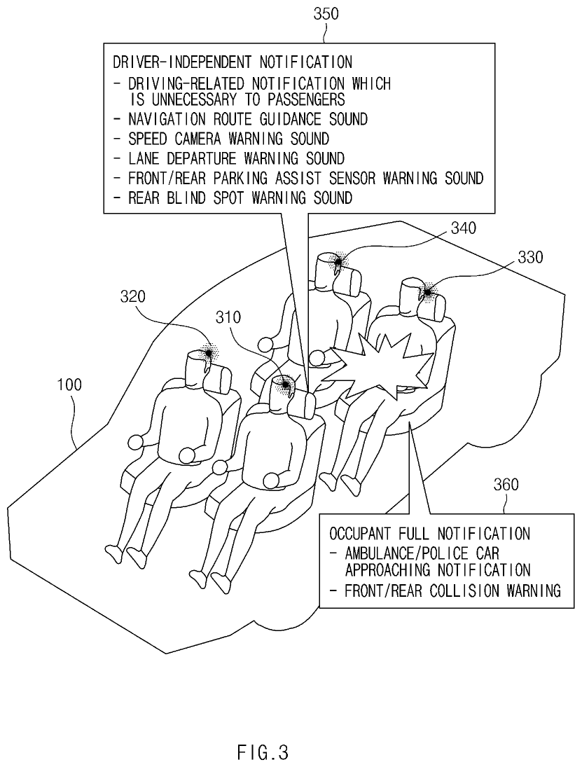

FIG. 3 is a diagram illustrating a control method in which a vehicle control device provides a service for outputting a guide sound or a warning sound through a portable external device according to an embodiment of the present disclosure.

One or more occupants may ride in a vehicle 100. For example, four occupants including one driver and three passengers may ride in the vehicle 100. However, the present disclosure is not limited thereto, and one driver may ride in the vehicle 100, or one driver and one or more passengers may ride in the vehicle 100.

Each of the one or more occupants may carry a portable external device (e.g., the portable external device 130 of FIG. 2). For example, the driver may carry a first portable external device 310, a first passenger may carry a second portable external device 320, a second passenger may carry a third portable external device 330, and a third passenger may carry a fourth portable external device 340. For example, each of the first portable external device 310, the second portable external device 320, the third portable external device 330, and the fourth portable external device 340 may be a wireless earphone. However, the present disclosure is not limited thereto, and each of the first portable external device 310, the second portable external device 320, the third portable external device 330, and the fourth portable external device 340 may be an electronic device capable of receiving sound data from the vehicle control device 110 through wireless communication and outputting sound according to the sound data.

The first portable external device 310 carried or worn by the driver may provide a driver-independent notification 350 to the driver. The driver-independent notification 350 may include a driving-related notification which is unnecessary for passengers, a navigation route guidance sound, a speed camera warning sound, a lane departure warning, a front/rear parking assist sensor warning sound, and a rear blind spot warning sound. The vehicle control device in the vehicle 100 (e.g., the vehicle control device 110 of FIG. 2) may transmit first sound data to the first portable external device 310 such that the first portable external device 310 outputs the driver-independent notification 350.

The portable external devices 310, 320, 330, and 340 carried or worn by all occupants may provide an occupant full notification 360 to the occupants individually. The occupant full notification 360 may include an ambulance/police car approaching notification and a front/rear collision warning.

The vehicle control device 110 may perform control such that the external sound is output to the portable external devices 310, 320, 330, and 340 carried or worn by all occupants in response to a specified external sound being recognized by a microphone in the vehicle. The specified external sound may be a horn sound or a siren sound. The specified external sound may be a sound originating from a police car or an ambulance. The vehicle control device 110 may transmit data for performing control to output a specified external sound to the portable external devices 310, 320, 330, and 340 such that the portable external devices 310, 320, 330, and 340 output the occupant full notification 360. The vehicle control device 110 may automatically switch the portable external devices 310, 320, 330, and 340 and output a warning guide to all occupants such that the specified external sound is output to the portable external devices 310, 320, 330, and 340 of the occupants.

Each of the second portable external device 320, the third portable external device 330, and the fourth portable external device 340 carried or worn by the passengers may provide the occupant full notification 360 to each passenger. The vehicle control device 110 may transmit the second sound data to the second portable external device 320, the third portable external device 330, and the fourth portable external device 340 such that each of the second portable external device 320, the third portable external device 330, and the fourth portable external device 340 outputs the occupant full notification 360.

The vehicle control device 110 may determine the position of the occupant in cooperation with the first portable external device 310, the second portable external device 320, the third portable external device 330, and the fourth portable external device 340. The vehicle control device 110 may determine the position of the user according to whether an occupant is seated on a vehicle seat. The vehicle control device 110 may transmit different sound data to the first portable external device 310, the second portable external device 320, the third portable external device 330, and the fourth portable external device 340 to provide a differentiated and independent sound service according to the position of the occupant

The vehicle control device 110 may control the first portable external device 310 such that the first portable external device 310 carried or worn by the driver provides a driver-specific service. The driver-specific service may include an active sound function for fun-driving necessary only for the driver, a navigation guide sound, an external warning sound detected by a vehicle sensor, and a High-pass guide sound. The vehicle control device 110 may transmit the first sound data to the first portable external device 310.

The vehicle control device 110 may allow the second portable external device 320, the third portable external device 330, and the fourth portable external device 340 carried or worn by the passengers to provide an occupant-specific service. The occupant-specific service may include dedicated media content, conversation transfer, call transfer, and motion sickness prevention functions required for each occupant. The vehicle control device 110 may transmit the second sound data to the second portable external device 320, the third portable external device 330, and the fourth portable external device 340.

The vehicle control device 110 may set priorities for the specific services. The priority may be determined according to importance of the content of the first portable external device 310, the second portable external device 320, the third portable external device 330, and the fourth portable external device 340. For example, in the case of an occupant-specific service, sound may be output in the order of the call transfer, conversation transfer, media content, and motion sickness prevention functions.

The vehicle control device 110 may transmit guide information to a portable external device carried by an occupant in response to an external sound recognized as an in-vehicle sound receiving device. For example, the vehicle control device 110 may recognize a horn sound or a siren sound of an emergency vehicle through a microphone in the vehicle. The emergency vehicle may be a vehicle such as a police car or an ambulance. The vehicle control device 110 may transmit warning guide information to the first portable external device 310, the second portable external device 320, the third portable external device 330, and the fourth portable external device 340 in response to a horn sound or a siren sound from a microphone. The vehicle control device 110 may automatically switch the first portable external device 310, the second portable external device 320, the third portable external device 330, and the fourth portable external device 340 such that the horn sound or the siren sound generated from the outside is output from all of the first portable external device 310, the second portable external device 320, the third portable external device 330, and the fourth portable external device 340.

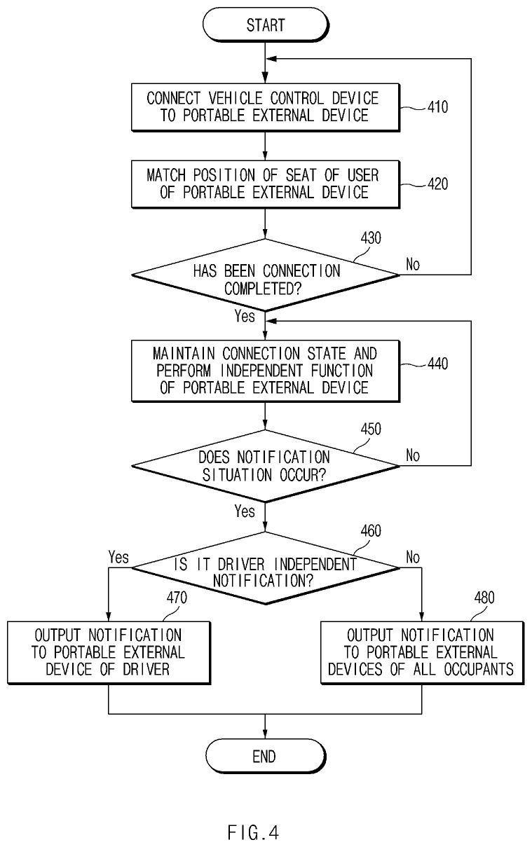

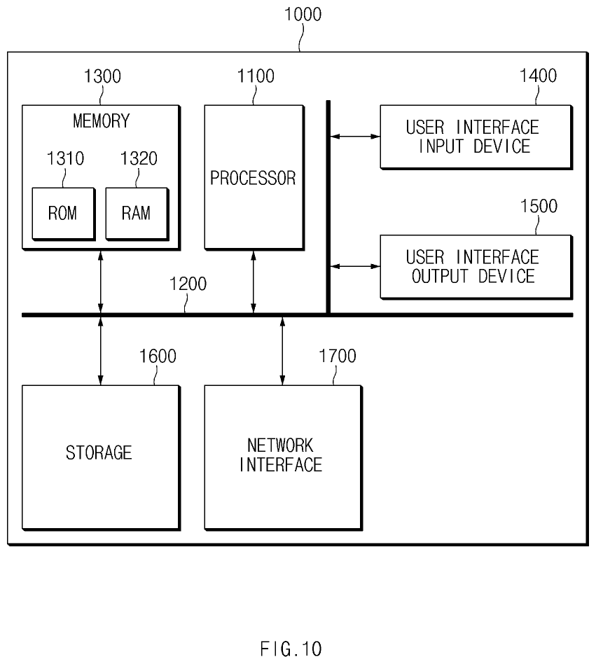

Hereinafter, it is assumed that the vehicle control device 110 performs the process of FIGS. 4 to 7. In addition, in the description of FIGS. 4 to 7, an operation described as being performed by the device may be understood as being controlled by a processor of the vehicle control device 110 (e.g., the processor 1100 of FIG. 10).

FIG. 4 is a flowchart illustrating a method of outputting, by a vehicle control device, a notification according to a situation in consideration of a position of each of a plurality of portable external devices according to an embodiment of the present disclosure.

In operation 410, the processor may connect the vehicle control device 110 and a portable external device (e.g., the portable external device 130 of FIG. 1). The vehicle control device 110 may be connected to the portable external device 130 through wireless communication. The portable external device 130 may be an earphone worn by a vehicle occupant.

In operation 420, the processor may match a seat position of the user of the portable external device 130. The processor may obtain position information of each of the portable external devices 130 of occupants.

In operation 430, the processor may determine whether the connection has been completed. When the connection between the vehicle control device 110 and the portable external device 130 has been completed (operation 430—YES), the processor may proceed to operation 440. When the connection between the vehicle control device 110 and the portable external device 130 has not been completed (operation 430—NO), the processor may return to operation 410.

In operation 440, the processor may control the portable external device 130 so as to maintain a connection state and perform an independent function of the portable external device 130. The vehicle control device 110 may independently secure the usability of the portable external device 130 carried or worn by each occupant in the vehicle. The vehicle control device 110 may classify sound services provided to the portable external device 130 based on seats of the vehicle. The portable external device 130 carried or worn by each of the occupants in the vehicle may independently reproduce media while interworking with the vehicle control device 110. The vehicle control device 110 may output a media sound to the vehicle infotainment system or the portable external device 130.

In operation 450, the processor may determine whether a notification situation has occurred. The notification situation may be a situation in which it is necessary to notify the occupant of the situation or danger through a notification sound or a warning sound. When the notification situation has occurred (operation 450—YES), the processor may proceed to operation 460. When the notification condition has not occurred (operation 450—NO), the processor may return to operation 440.

In operation 460, the processor may determine whether the notification situation corresponds to a driver-independent notification (e.g., the driver-independent notification 350 of FIG. 3). The driver-independent notification 350 may include driving-related guidance or direct reproduction of a safety warning sound to the driver. When the notification situation corresponds to the driver-independent notification 350 (operation 460—YES), the processor may proceed to operation 470. When the notification situation does not correspond to the driver-independent notification 350 (operation 460—NO), the processor may proceed to operation 480.

In operation 470, the processor may output a notification to the driver's portable external device 130. When the notification situation corresponds to the driver-independent notification 350, the processor may control the driver's portable external device 130 so as to directly reproduce driving-related guidance or a safety warning sound to the driver. The processor may control the driver's portable external device 130 to simultaneously perform independent media reproduction and guidance functions. The processor may set the priority of the output of the drive's portable external device 130 to first output the driving related guidance or the safety warning sound.

In operation 480, when the notification situation does not correspond to the driver independent notification 350, the processor may output a notification to the portable external device 130 of each of the occupants. When the notification situation is driving-related guidance, the processor may control the portable external device 130 of each of the occupants to output driving-related guidance to the occupants. The processor may selectively provide sound data to the portable external device 130 of a passenger such that the safety warning sound is not output from the portable external device 130 of the passenger except for the driver. The processor may control portable external devices 130 of all occupants to selectively output independent media reproduction and vehicle-linked convenience functions.

The processor may output a notification to the portable external device 130 of each of the occupants when a situation in which a room full notification is required occurs. The processor may output a notification to a speaker closest to a seat on which an occupant who does not wear the portable external device 130 sits.

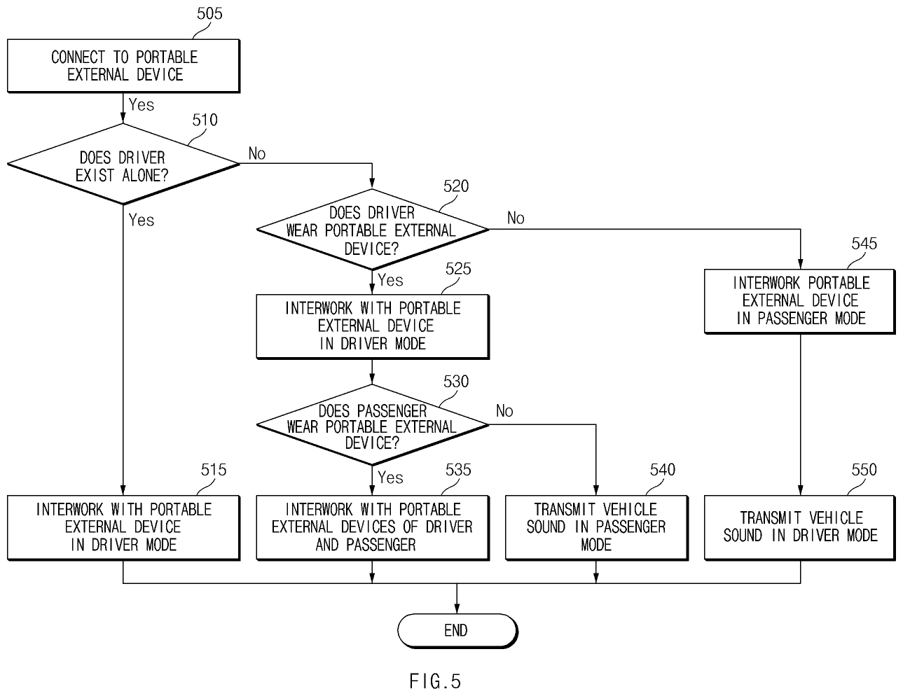

FIG. 5 is a flowchart illustrating a method for independently providing a sound service to each of a plurality of portable external devices in a vehicle control device according to an embodiment of the present disclosure.

A vehicle control device (e.g., the vehicle control device 110 of FIG. 1) may flexibly control the sound output of a sound system of a vehicle (e.g., the vehicle 100 of FIG. 3) according to a state of being connected to a portable external device (e.g., the portable external device 130 of FIG. 1). The vehicle control device 110 may change a means and method for outputting a driving warning sound or a guide sound and a media sound source of the vehicle 100 according to a state of being connected to the portable external device 130.

In operation 505, the processor may connect the portable external device 130 to the vehicle control device 110.

In operation 510, the processor may determine whether there is only a driver in the vehicle 100. When the portable external device 130 is connected to the vehicle control device 110, the vehicle control device 110 may recognize an occupant in the vehicle 100 by using information on a seat sensor of the vehicle 100, connection information of the portable external device 130, and/or indoor camera information of the vehicle 100. The vehicle control device 110 may recognize that only the driver is present in the vehicle 100 when the drivers seat sensor is turned on, all seat sensors of other seats except the drivers seat are turned off, and the portable external device 130 is connected. When there is only the driver in the vehicle 100 (operation 510—YES), the processor may proceed to operation 515. The vehicle control device 110 may recognize that a driver and a passenger are present in the vehicle 100 when the seat sensor of the drivers seat and the seat sensors of seats other than the drivers seat are turned on and the portable external device 130 is connected. When there is a driver and a passenger in the vehicle 100 (operation 510—NO), the processor may proceed to operation 520.

In operation 515, the processor may link the portable external device 130 in a driver mode. When the vehicle control device 110 interworks with the drivers portable external device 130 under the condition that there is no passenger inside the vehicle 100, the vehicle control device 110 may control a sound system provided inside the vehicle 100 to be optimized for the drive's portable external device 130. The vehicle control device 110 may control the drivers portable external device 130 such that the drivers portable external device 130 outputs a driving warning sound, a guide sound, and a media. The vehicle control device 110 may control the sound system of the vehicle 100 to turn off the sound system of the vehicle 100 or output a sound to assist the drive's portable external device 130.

In operation 520, the processor may determine whether the driver wears the portable external device 130. The vehicle control device 110 may recognize whether the driver is wearing the portable external device 130 by using a camera provided inside the vehicle 100. When the driver wears the portable external device 130 (operation 520—YES), the processor may proceed to operation 525. When the driver does not wear the portable external device 130 (operation 520—NO), the processor may proceed to operation 545.

In operation 525, the processor may interwork with the portable external device 130 in the driver mode.

In operation 530, the processor may determine whether a passenger wears the portable external device 130. When the passenger wears the portable external device 130 (operation 530 —YES), the processor may proceed to operation 535. When the passenger does not wear the portable external device 130 (operation 530—NO), the processor may proceed to operation 540.

In operation 535, the processor may interwork with the portable external device 130 of each of a driver and a passenger.

In operation 540, the processor may link the sound of the vehicle 100 in a passenger mode. When the vehicle control device 110 interworks with the drivers portable external device 130 under a condition that the driver and the passenger ride together in the vehicle 100, the vehicle control device 110 may independently control a sound system inside the vehicle 100 for the driver and the passenger. The vehicle control device 110 may control the drivers portable external device 130 so as to output a driving warning sound, a guide sound, and a media through the driver's portable external device 130. The vehicle control device 110 may control the sound system of the vehicle 100 so that the sound system of the vehicle 100 is optimized for a seat of a passenger. For example, the vehicle control device 110 may control the sound system of the vehicle 100 to remove a driving-related guide sound. As another example, the vehicle control device 110 may control the sound system of the vehicle 100 to reproduce media independent of the driver's portable external device 130.

In operation 545, the processor may interwork with the portable external device 130 in the passenger mode. When the driver does not wear the portable external device 130, the vehicle control device 110 may interwork with the portable external device 130 in a passenger mode.

In operation 550, the processor may link the sound of the vehicle 100 in the driver mode. The vehicle control device 110 may control the sound system in the vehicle 100 independently for the driver and the passenger when only the portable external device 130 of the passenger interworks with the vehicle control device 110 under the condition that the driver and the passenger ride together in the vehicle 100. The vehicle control device 110 may perform control to output a media to the portable external device 130 of the passenger. The vehicle control device 110 may provide sound signal information being reproduced inside the vehicle 100 to the portable external device 130 of the passenger. The passengers portable external device 130 may perform a noise canceling function using the sound signal information. The vehicle control device 110 may control the vehicle sound system such that the sound system in the vehicle 100 is optimized for the driver's seat. For example, the vehicle control device 110 may control the sound system of the vehicle 100 to output a driving-related warming and guide sound through a driver's seat speaker. As another example, the vehicle control device 110 may control the sound system of the vehicle 100 to reproduce media independent of the passenger.

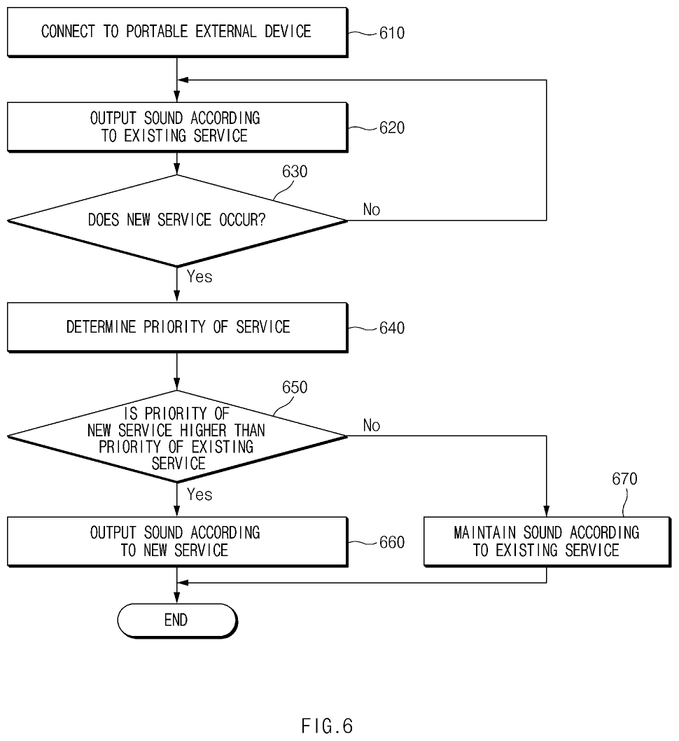

FIG. 6 is a flowchart illustrating a method for determining services provided by a plurality of portable external devices in a vehicle control device according to a priority according to an embodiment of the present disclosure.

The vehicle control device 110 may set a priority of voice information necessary for occupants in the vehicle 100. The vehicle control device 110 may control the portable external device 130 to provide voice information according to the set priority. The vehicle control device 110 may provide an optimized sound service to an occupant.

In operation 610, the processor may connect the vehicle control device 110 to the portable external device 130.

In operation 620, the processor may control the portable external device 130 to output a sound according to an existing service.

In operation 630, the processor may determine whether a new service has occurred. When a new service has occurred (operation 630—YES), the processor may proceed to operation 640. The processor may return to operation 610 when a new service has not occurred (operation 630—NO).

In operation 640, the processor may determine the service priority. The processor may compare the ranking of the new service with that of an existing service.

The vehicle control device 110 may independently manage a priority of the sound service for the portable external device 130 of the driver and a priority of the sound service for the portable external device 130 of the passenger.

The vehicle control device 110 may set the priorities of the sound services for the driver's portable external device 130 in the following order of (1) to (6).

(1) Warning and guidance, external situation awareness
(2) Route guide for driver
(3) Call mode
(4) Conversation mode
(5) Media content
(6) Active sound

The vehicle control device 110 may set the priorities of the sound services for the portable external devices 130 of the passengers in the following order of <1> to <4>.

<1> Call mode
<2> Conversation mode
<3> Motion sickness mode that provides driving-related information and induces brain waves
<4> Media content

When a conversation partner is using a service with a higher priority than a conversation in a case where the portable external device 130 attempts the conversation, the vehicle control device 110 may control the portable external device 130 to guide the conversation partner's state.

In operation 650, the processor may determine whether the priority of the new service is higher than that of an existing service. When the priority of the new service is higher than that of the existing service (operation 650—YES), the processor may proceed to operation 660. When the priority of the new service is lower than that of the existing service (operation 650—NO), the processor may return to operation 670.

In operation 660, the processor may control the portable external device 130 to output a sound according to the new service.

In operation 670, the processor may control the portable external device 130 to maintain the sound according to the existing service.

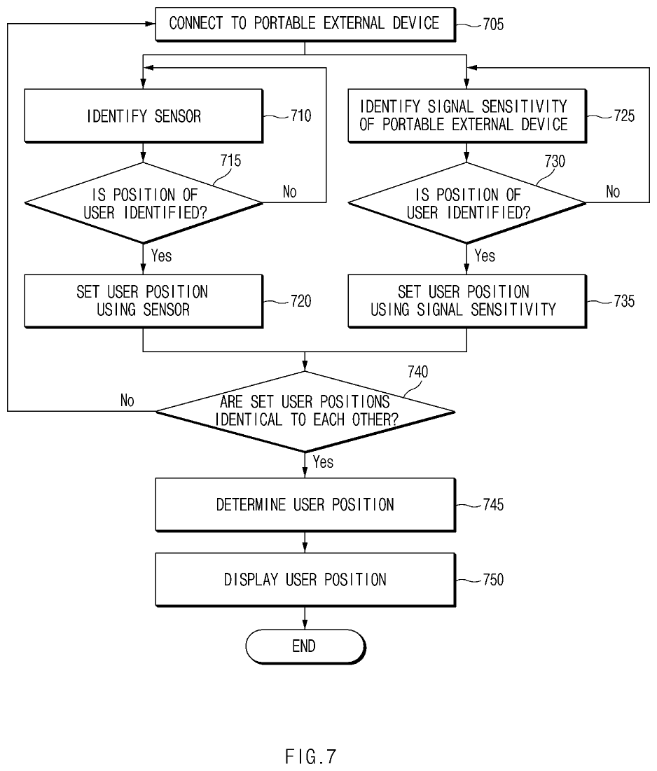

FIG. 7 is a flowchart illustrating a method for determining a position of a user of a portable external device in a vehicle control device according to an embodiment of the present disclosure.

The vehicle control device 110 may automatically determine whether a role of an occupant is a driver or a passenger based on a position of the seat on which an occupant is seated. The vehicle control device 110 may compare a signal sensitivity of a seat sensor of the vehicle 100 and a signal sensitivity of the portable external device 130 of the occupant.

In operation 705, the processor may connect the vehicle control device 110 to the portable external device 130.

In operation 710, the processor may identify a sensor in the vehicle 100.

In operation 715, the processor may determine whether the position of the user is identified. When the position of the user is identified (operation 715—YES), the processor may proceed to operation 720. When the position of the user is not identified (operation 715—NO), the processor may return to operation 710.

In operation 720, the processor may set the user's position using a sensor. The sensor may be a seat sensor or a rear seat detection sensor of the vehicle 100. The vehicle control device 110 may extend a function of a sensor used to perform another function in the vehicle 100 to use the sensor as a sensor for setting a users position.

In operation 725, the processor may identify a signal sensitivity of the portable external device 130.

In operation 730, the processor may determine whether the position of the user is identified. The use's position may include information on a position of a seat on which an occupant sits. When the position of the user is identified (operation 730—YES), the processor may proceed to operation 735. When the position of the user is not identified (operation 715—NO), the processor may return to operation 725.

In operation 735, the processor may set the users position using the signal sensitivity. The vehicle control device 110 may implement the signal sensitivity of the portable external device 130 by extending functions of an antenna, a smart key, a radio, or a speaker used in the vehicle 100. The vehicle control device 110 may control the antenna, the smart key, the radio, or the speaker such that the antenna, the smart key, the radio, or the speaker transmits a position identification signal. The vehicle control device 110 may receive feedback on the reception sensitivity of the position identification signal from the portable external device 130.

In operation 740, the processor may determine whether the set user positions match each other. When the set user positions match each other (operation 740—YES), the processor may proceed to operation 745. When the set user positions are different from each other (operation 740—NO), the processor may return to operation 705. The vehicle control device 110 may attempt re-identification when the user position identified by the portable external device 130 is different from the user position detected by the sensor of the vehicle 100. After re-identification is attempted, the vehicle control device 110 may manually set the user's position through the user's confirmation.

In operation 745, the processor may determine a user position. The vehicle control device 110 may determine a position of an occupant using a sensor and a signal sensitivity.

In operation 750, the processor may display the user position. The vehicle control device 110 may display a determined result to the user through a display in the vehicle 100.

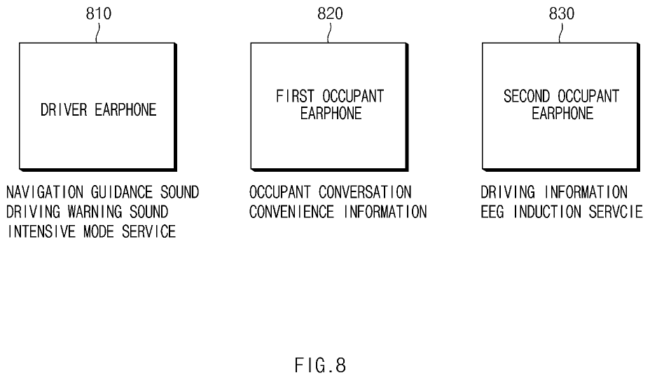

FIG. 8 is a diagram illustrating a personalized service provided by each of a plurality of portable external devices according to an embodiment of the present disclosure.

The vehicle control device 110 may be connected to a driver earphone 810, a first occupant earphone 820, and a second occupant earphone 830.

The vehicle control device 110 may control the driver earphone 810 such that a navigation guidance sound, a driving warning sound, and an intensive mode service are output to the driver earphone 810. The vehicle control device 110 may perform control to provide first sound data including the navigation guidance sound and the driving warning sound only to the driver earphone 810 such that the navigation guidance sound and the driving warning sound are output only to the driver earphone 810. The vehicle control device 110 may independently provide an intensive mode sound service for relieving drowsiness in a manner such as EEG (Electroencephalogram) induction when the driver is detected as being drowsy or tired. Accordingly, the vehicle control device 110 may independently control the driver earphone 810 to provide a personalized service to the driver without disturbing other occupants.

The vehicle control device 110 may control the first occupant earphone 820 such that occupant conversation and convenience information are output to the first occupant earphone 820. The vehicle control device 110 may provide occupant conversation or convenience information only through the first occupant earphone 820. As an example of convenience information, an arrival guidance speech such as “arrival guidance, 5 minutes before arrival at set destination” may be output from the first occupant earphone 820. Accordingly, the vehicle control device 110 may independently control the first occupant earphone 820 to provide a personalized service to the first occupant without disturbing other occupants.

The vehicle control device 110 may control the second occupant earphone 830 to provide driving information and an EEG induction service to the second occupant earphone 830. The vehicle control device 110 may provide driving information or the EEG induction service only through the second occupant earphone 830. The second occupant may be in an uncomfortable state due to motion sickness. The EEG induction service may be a motion sickness alleviation function that is independently provided only to a corresponding occupant when a second occupant in an uncomfortable state such as motion sickness is identified among occupants. Accordingly, the vehicle control device 110 may independently control the second occupant earphone 830 to provide a personalized service to the second occupant without disturbing other occupants.

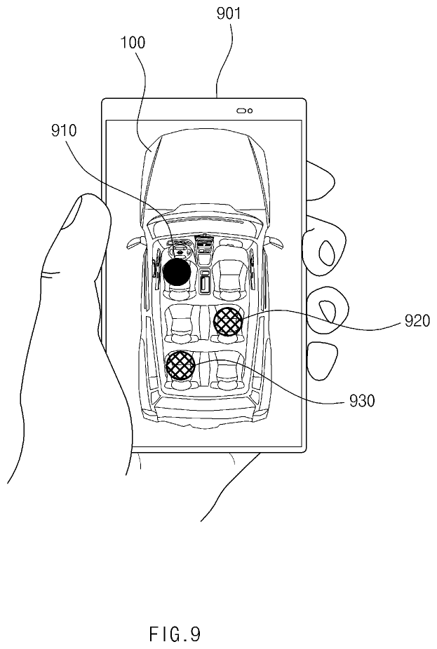

FIG. 9 is a diagram illustrating a personalized service provided by an external device according to an embodiment of the present disclosure.

An external device 901 may be an electronic device including a display that visually displays the vehicle 100, such as a smart phone, a tablet, or a notebook. The external device 901 may visually display the positions of a driver 910, a first occupant 920, and a second occupant 930 in the vehicle 100.

The vehicle control device 110 may interwork with the external device 901. The driver 910, the first occupant 920, and the second occupant 930 may be selected through the external device 901. A sound service may be independently provided for each occupant selected by the external device 901.

The vehicle control device 110 may transmit user position and attribute information identified by interworking with the portable external devices 130 of the driver 910, the first occupant 920, and the second occupant 930, to the external device 901. The external device 901 may display the user position and attribute information on the display. Accordingly, the external device 901 may set a personalized sound service for each of the driver 910, the first occupant 920, and the second occupant 930.

FIG. 10 illustrates a computing system according to an embodiment of the present disclosure.

Referring to FIG. 10, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

The present disclosure may extend a function of interworking with each of a plurality of portable devices when the vehicle control device interworks with the plurality of portable devices in a vehicle.

Further, when the vehicle control device interworks with a plurality of portable devices in the vehicle, the vehicle control device may distinguish information required for each of the driver and the passenger and provide different information to the portable external devices carried by the driver and the portable external device carried by the passenger to provide a personalized service suitable for the driver and the passenger.

Further, the present disclosure may provide information differentially according to the priority of information required for the portable external device carried by the driver and the portable external device carried by the passenger, thereby reducing unnecessary service provision to the driver and passengers and increasing the effectiveness of personalized services.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A venire control device, comprising:
a memory;
a network interface; and
a processor,
wherein the processor is configured to:
connect to a portable external device through a communication channel,
identify a position of an occupant carrying or wearing the portable external device,
determine whether the occupant is a driver or a passenger based on the position of the occupant, and
transmit sound data for providing a sound service suitable for the occupant to the portable external device according to whether the occupant is the driver or the passenger.

2. The vehicle control device of claim 1, wherein the processor is configured to receive a user position signal from a sensor in a vehicle to identify the position of the occupant.

3. The vehicle control device of claim 1, wherein the processor is configured to provide a first sound data related to a driving-related warning and route guidance to the portable external device in response to the occupant being the driver.

4. The vehicle control device of claim 3, wherein the first sound data includes a driving-related notification, a navigation route guidance sound, a speed camera warning sound, a lane departure warning, a front/rear parking assist sensor warning sound, and a rear blind spot warning sound, which are unnecessary for passengers.

5. The vehicle control device of claim 1, wherein the processor is configured to provide a second sound data related to guidance and convenience services to the portable external device in response to the occupant being the passenger.

6. The vehicle control device of claim 1, wherein the processor is configured to perform control such that a specified external sound is output to portable external devices carried or worn by all of the occupants in response to the specified external sound such as a horn sound or a siren sound being recognized by a microphone in a vehicle.

7. The vehicle control device of claim 1, wherein the processor is configured to control the portable external device of the driver such that the portable external device of the driver outputs a driving warning sound, a guidance sound, and a media when interlocking with the portable external device of the driver under condition that the passenger is absent in a vehicle.

8. The vehicle control device of claim 7, wherein the processor is configured to control a sound system of the vehicle to turn off the sound system of the vehicle or to output a sound to assist the portable external device of the driver.

9. The vehicle control device of claim 1, wherein the processor is configured to control a sound system of a vehicle to remove a driving-related guide sound when interworking with the portable external device of the driver under condition that the driver and the passenger are riding together in the vehicle.

10. The vehicle control device of claim 1, wherein the processor is configured to independently manage a priority of a sound service for the portable external device of the driver and a priority of a sound service for the portable external device of the passenger.

11. The vehicle control device of claim 10, wherein the processor is configured to set the priority of the sound service for the portable external device of the driver in order of: (1) warning and guidance including external situation awareness, (2) route guidance for drivers, (3) call mode, (4) conversation mode, (5) media content, and (6) active sound.

12. The vehicle control device of claim 10, wherein the processor is configured to set the priority of the sound service for the portable external device of the passenger in order of: call mode, conversation mode, motion sickness mode that provides driving-related information and induces an electroencephalogram (EEG), and media content.

13. A vehicle control method, comprising:
connecting, by a vehicle control device, to a portable external device through a communication channel;
identifying, by a processor of the vehicle control device, a position of an occupant carrying or wearing the portable external device;
determining by the processor, whether the occupant is a driver or a passenger based on the position of the occupant, and
transmitting, by the processor, sound data for providing a sound service suitable for the occupant to the portable external device according to whether the occupant is the driver or the passenger.

14. The vehicle control method of claim 13, further comprising:
receiving, by the processor, a user position signal from a sensor in a vehicle to identify the position of the occupant.

15. The vehicle control method of claim 13, further comprising:
providing, by the processor, a first sound data related to a driving-related warming and route guidance to the portable external device in response to the occupant being the driver.

16. The vehicle control method of claim 15, wherein the first sound data includes a driving-related notification, a navigation route guidance sound, a speed camera warning sound, a lane departure warning, a front/rear parking assist sensor warning sound, and a rear blind spot warning sound, which are unnecessary for passengers.

17. The vehicle control method of claim 13, further comprising:
providing, by the processor, a second sound data related to guidance and convenience services to the portable external device in response to the occupant being the passenger.

18. The vehicle control method of claim 13, further comprising:
preforming, by the processor, control such that a specified external sound is output to portable external devices carried or worn by all of the occupants in response to the specified external sound such as a horn sound or a siren sound being recognized by a microphone in a vehicle.

19. The vehicle control method of claim 13, further comprising:
controlling, by the processor, the portable external device of the driver such that the portable external device of the driver outputs a driving warning sound, a guidance sound, and a media when interlocking with the portable external device of the driver when the passenger is absent in a vehicle.

20. The vehicle control method of claim 19, further comprising:
controlling, by the processor, a sound system of the vehicle to turn off the sound system of the vehicle or to output a sound to assist the portable external device of the driver.
